(19) United States
(12) Patent Application Publication
(10) Pub. No.: US 2024/0185535 A1
(43) Pub. Date: Jun. 6, 2024

(54) METHOD FOR COLLABORATIVELY CREATING AUGMENTED REALITY STORY AND SYSTEM THEREFOR

(71) Applicant: 3DBear Oy, Vantaa (FI)

(72) Inventor: Aaron Joensuu, Vantaa (FI)

(73) Assignee: 3DBear Oy, Vantaa (FI)

(21) Appl. No.: 18/062,280

(22) Filed: Dec. 6, 2022

(51) Int. Cl. G06T 19/00; G06T 19/20

(52) U.S. Cl. CPC G06T 19/006; G06T 19/20; G06T 2219/024; G06T 2219/2004; G06T 2219/2012; G06T 2219/2016

(57) ABSTRACT

A method for collaboratively creating at least one augmented reality (AR) story includes receiving a selection of at least one first virtual object that is added to at least one AR story, digitally superimposing at least one first virtual object on a first real-world environment to generate a first AR creation, publishing first AR creation having a first metadata associated therewith for modification, receiving a selection of a virtual object from amongst at least one first virtual object that is extracted from first AR creation, digitally superimposing virtual object on a second real-world environment to generate a second AR creation, publishing second AR creation having a second metadata associated therewith and generating a timeline, timeline comprising all AR creations of at least one AR story arranged in a chronological order with their corresponding timestamps and metadata.

### TECHNICAL FIELD

The present disclosure also relates to a method for collaboratively creating at least one augmented reality (AR) story. The present disclosure also relates to an apparatus for collaboratively creating at least one augmented reality (AR) story. The present disclosure also relates to a system comprising a server communicably coupled to a plurality of apparatuses.

### BACKGROUND

Nowadays, providing an artificial environment experience to the user is an emerging technological trend. Many techniques are used to generate illusions for providing an artificial environment. Such techniques may include three-dimensional (3D) modelling, Virtual Reality (VR), and Augmented Reality (AR). The artificial environment experience enables the user to interact with the virtual objects in an artificial world. Suitably, the usage and need for 3D models has grown and continues to grow, however, the level of accessibility is still low.

Notably, Virtual Reality (VR) has been quite popular in providing artificial experiences to the user for the past few decades. Typically, VR uses computer technology to create a simulated environment. In this regard, the VR places the user inside a 3D world where the environment and the objects are virtual. Moreover, to experience VR the user must have a computing device powerful enough to process the 3D simulated world. Furthermore, to experience the VR world, the user is configured to wear a headset covering the eyes, ears and at least partly the nose. However, such a headset is bulky and may be uncomfortable to wear such as for a long duration. Moreover, such a headset may provide the immersive experience with some unpleasant and disorienting side-effects such as headache, nausea, and the like.

A solution to this problem is the use of AR. AR provides the user an interactive experience in a real-world environment where virtual objects reside in the real-world, enhanced by the computing device. In addition, AR enables the recording of the real-world environment and the superimposed 3D virtual objects. Moreover, AR can be provided on any computing device that has a camera therein. AR enables users to create and experience a mixed world with both the real-world environment and the 3D virtual objects. However, there is a limited amount of applications that are available to experience such a virtual environment. Moreover, creating AR content can be complex, expensive and time consuming. Additionally, there is no as such platform that enables the sharing and reusing of the 3D virtual objects present in an AR recording.

Additionally, a conventional AR recording lacks information about superimposed 3D virtual objects or other virtual objects therein. Moreover, with the increase in adoption of 3D and virtual environments, 3D virtual objects will be key in sharing to the user.

Therefore, in light of the foregoing discussion, there exists a need to overcome the aforementioned drawbacks associated with the conventional way of interacting with the virtual environment.

### SUMMARY

The present disclosure seeks to provide a method for collaboratively creating at least one augmented reality (AR) story. The present disclosure also seeks to provide an apparatus for collaboratively creating at least one augmented reality (AR) story. The present disclosure also seeks to provide a system comprising a server communicably coupled to a plurality of apparatuses. An aim of the present disclosure is to provide a solution that overcomes at least partially the problems encountered in prior art.

In a first aspect, an embodiment of the present disclosure provides a method for collaboratively creating at least one augmented reality (AR) story, the method comprising:
a. receiving a selection of at least one first virtual object that is to be added to the at least one AR story;
b. digitally superimposing the at least one first virtual object on a representation of a first real-world environment to generate a first AR creation of the at least one AR story;
C. publishing the first AR creation having a first metadata associated therewith for modification thereof;
d. receiving a selection of a virtual object from amongst the at least one first virtual object that is to be extracted from the first AR creation;
e. digitally superimposing the virtual object on a representation of a second real-world environment to generate a second AR creation of the at least one AR story;
f. publishing the second AR creation having a second metadata associated therewith; and
g. generating a timeline of the at least one AR story, the timeline comprising all the AR creations of the at least one AR story arranged in a chronological order along with their corresponding timestamps and metadata.

In a second aspect, an embodiment of the present disclosure provides an apparatus for collaboratively creating at least one augmented reality (AR) story, the apparatus comprising:
a display screen; and
a processor configured to:
a. receive a selection of at least one first virtual object that is to be added to the at least one AR story;
b. digitally superimpose the at least one first virtual object on a representation of a first real-world environment to generate a first AR creation of the at least one AR story;
c. publish the first AR creation having a first metadata associated therewith for modification thereof;
d. receive a selection of a virtual object from amongst the at least one first virtual object that is to be extracted from the first AR creation;
e. digitally superimpose the virtual object on a representation of a second real-world environment to generate a second AR creation of the at least one AR story;
f. publish the second AR creation having a second metadata associated therewith; and
g. generate a timeline of the at least one AR story, the timeline comprising all the AR creations of the at least one AR story arranged in a chronological order along with their corresponding timestamps and metadata.

In a third aspect, a system comprising a server communicably coupled to a plurality of apparatuses according to the second aspect, wherein the plurality of apparatuses for collaboratively creating at least one augmented reality (AR) story, the server being configured to store, in a database associated with the server, a timeline of at least one AR story, the timeline comprising all AR creations of the at least one AR story arranged in a chronological order along with their corresponding timestamps and metadata.

In a fourth aspect, an embodiment of the present disclosure provides a computer program product comprising a non-transitory computer-readable storage medium having computer-readable instructions stored thereon, the computer-readable instructions being executable by a computing device comprising processor to execute the method according to the first aspect.

Embodiments of the present disclosure substantially eliminate or at least partially address the aforementioned problems in the prior art and enable the user to create their own AR creation. Moreover, the user can interact with the AR creations of other users as well. Furthermore, the AR creation created by the first user can be modified by the other user to create a new AR creation (re-versioning).

Additional aspects, advantages, features, and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for collaboratively creating at least one augmented reality (AR) story, in accordance with an embodiment of the present disclosure;

FIG. 2 is an exemplary illustration of an AR creation, in accordance with an embodiment of the present disclosure; and

FIG. 3 is an exemplary illustration of creating at least one augmented reality (AR) story, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a method for collaboratively creating at least one augmented reality (AR) story, the method comprising:
a. receiving a selection of at least one first virtual object that is to be added to the at least one AR story;
b. digitally superimposing the at least one first virtual object on a representation of a first real-world environment to generate a first AR creation of the at least one AR story;
C. publishing the first AR creation having a first metadata associated therewith for modification thereof;
d. receiving a selection of a virtual object from amongst the at least one first virtual object that is to be extracted from the first AR creation;
e. digitally superimposing the virtual object on a representation of a second real-world environment to generate a second AR creation of the at least one AR story;
f. publishing the second AR creation having a second metadata associated therewith; and
g. generating a timeline of the at least one AR story, the timeline comprising all the AR creations of the at least one AR story arranged in a chronological order along with their corresponding timestamps and metadata.

In a second aspect, an embodiment of the present disclosure provides an apparatus for collaboratively creating at least one augmented reality (AR) story, the apparatus comprising:
a display screen; and
a processor configured to:
a. receive a selection of at least one first virtual object that is to be added to the at least one AR story;
b. digitally superimpose the at least one first virtual object on a representation of a first real-world environment to generate a first AR creation of the at least one AR story;
C. publish the first AR creation having a first metadata associated therewith for modification thereof;
d. receive a selection of a virtual object from amongst the at least one first virtual object that is to be extracted from the first AR creation;
e. digitally superimpose the virtual object on a representation of a second real-world environment to generate a second AR creation of the at least one AR story;
f. publish the second AR creation having a second metadata associated therewith; and
g. generate a timeline of the at least one AR story, the timeline comprising all the AR creations of the at least one AR story arranged in a chronological order along with their corresponding timestamps and metadata.

In a third aspect, a system comprising a server communicably coupled to a plurality of apparatuses according to the second aspect, wherein the plurality of apparatuses for collaboratively creating at least one augmented reality (AR) story, the server being configured to store, in a database associated with the server, a timeline of at least one AR story, the timeline comprising all AR creations of the at least one AR story arranged in a chronological order along with their corresponding timestamps and metadata.

In a fourth aspect, an embodiment of the present disclosure provides a computer program product comprising a non-transitory computer-readable storage medium having computer-readable instructions stored thereon, the computer-readable instructions being executable by a computing device comprising processor to execute the method according to the first aspect.

The present disclosure provides the aforementioned method, the aforementioned apparatus, and the aforementioned system for collaboratively creating at least one augmented reality (AR) story. The method aims for the user to create, interact with and modify the AR creation. Moreover, the AR creation comprises one or more virtual objects digitally superimposed on the representation of the real-world environment in real-time. Beneficially, the user can access the AR creation of another user and can modify their own AR creations by taking inspiration from the other user's AR creations and by copying the virtual objects of the other user's AR creations. Additionally, all the modifications done on the original AR creation are timestamped, thereby enabling the user to use any of the AR creations of the respective timeline and modify it.

Throughout the present disclosure, the term “augmented reality (AR) story” as used herein refers to a story created by publishing at least one AR creation. It will be appreciated that each time a user publishes the AR creation the AR story is created. The term “AR creation” as used herein refers to an interaction between a virtual object with the real-world environment created by a user, resulting in a three-dimensional (3D) representation in the real-world environment. Notably, the user may be any entity such as a person (i.e., a human being) or a virtual program (such as, an autonomous program or a bot). Optionally, the AR story may be the AR creation created from start, or by copying the contents of an existing AR creation. Moreover, the AR creation may be published as a video, image, image sequence, GIF, and the like. Optionally, the AR creation may be a short video with a duration of 0.1 to 60 seconds. In this regard, the AR story comprises multiple frames displaying consecutive images (frames) to form the video. Additionally, the user may record and/or publish the AR creation in an image or a video format. It will be appreciated that the other users may view and/or modify the AR creation of the first user to create an alternative version (namely, re-versioning) of the AR creation. For example, a first user has published a first AR creation, a second user can reconstruct the published first AR creation in AR Space (user interface of the second user) by adding the virtual object(s) by downloading from the internet or loading from local storage and/or modifying the virtual object(s) of the published first AR creation and publishing a second AR creation.

The term “virtual object” as used herein refers to a depiction of a visual representation of an object inserted within the real-world environment. Optionally, the virtual object may be a depiction of a real object. More optionally, the virtual object may be stored images inserted within the real-world environment. Moreover, the user may place multiple virtual objects in the real-world environment. It will be appreciated that the one or more virtual objects may be available to the user. Furthermore, the user may change the shape, size, colour, texture, and the like of the virtual object. In this regard, the user uses a user device, an electronic device, that is capable of enabling the user to create and/or modify an AR creation thereon. Notably, the user device is configured to provide a user interface over which the AR creation can be created and/or modified. The user interface is a space where interaction between the user and the user device occurs. In addition, the virtual object may be received on the user interface to create the AR creation. It will be appreciated that the receiving of the virtual object in the real-world environment on the user interface may be done by uploading the virtual object from a library, downloading it from a plurality of online sources, and the like of the user interface and is placed in the real-world environment. Moreover, the user may place a plurality of the virtual object in a given AR creation. Optionally, a virtual object may be selected from at least one virtual object from the first AR creation for use in creating a new AR creation (such as a second AR creation). Optionally, the virtual object may be an image of an animal, building, text, tree, chair, an art design, and the like. In addition, the virtual object is placed within the real-world environment such that a user can interact therewith.

Optionally, the method comprises obtaining the representation of the given real-world environment from a data repository or a camera of a given user device. Typically, the user is configured to provide the real-world environment on the user interface over which the virtual objects can be superimposed. In addition, the real-world environment may be a representation of a landscape, office, house, restaurant and the like that may be captured by the user through a camera or may be stored in the data repository. The term “data repository” as used herein refers to a storage medium that may be configured to store the images. Optionally, the data repository may be present within the user device or may be connected to the user device. Optionally, the data repository may include, but is not limited to, internal storage, external storage, a universal serial bus (USB), a Hard Disk Drive (HDD), a Flash memory, a Secure Digital (SD) card, a Solid-State Drive (SSD), a computer-readable storage medium or any suitable combination of the foregoing. Moreover, the camera of the user device is configured to capture the real-world environment. Notably, the representation of the real-world environment obtained from the data repository or camera provides the real-world environment to the user device to digitally superimpose the virtual object thereon.

The term “digitally superimposing” as used herein refers to the placing of the virtual object in the real-world environment such that both the virtual object and the real-world environment are evident. For example, digitally superimposing a chair into a real-world environment such that the user can navigate around the chair and inspect the chair. Typically, digitally superimposing enables the user to identify how a real object looks when placed in the real-world environment. In particular, digitally superimposing provides the simulation of the real object by placing the virtual object in the representation of the real-world environment. Herein, the selected virtual object is digitally superimposed on the first and the second AR creation as per the user requirement. In an example, the at least one virtual object added to the first AR story may be revisited and one or more virtual objects may be selected from the at least one virtual object added to the first AR story to be added to the second AR creation.

Optionally, the method further comprises manipulating a given virtual object upon its digital superimposition in a representation of a given real-world environment. Notably, the virtual object digitally superimposed on the real-world environment may be modified such as, scaled, coloured, textured, rotated or repositioned by the user. The mesh of a 3D model may be modified. In addition, the mesh of a virtual object can be stretched, shaped, formed, and the like. Beneficially, manipulating the given virtual object in the real-world environment allows the user to virtually observe the given superimposed virtual object in the real-world scenario.

The term “metadata” as used herein refers to a file linked to the AR creation and the virtual object(s) of the AR creation, which is configured to save the data associated with the corresponding AR story into the database. Notably, each AR story may have a corresponding metadata file associated with it to store the information about the corresponding AR creation. Moreover, the metadata contains information about the position, rotation, and/or any other modifications performed on the virtual object that may be required to accurately reconstruct the AR creation at a later time. In an example, the first AR story has a first metadata associated therewith. Similarly, the second AR story has a second metadata associated therewith, and so on.

Optionally, the method comprises linking, in a database, the first, second and additional AR creations of the AR story and the first, second and additional metadata in a chronological order. Herein, the metadata associated with the AR creation is stored in the chronological order of time in the database. Beneficially, the said stored metadata in chronological order enables the user to access the AR creation at a specific time with the timeline. Furthermore, the said timeline has timestamping associated with it that provides the changes performed by the user in the AR creation correspondingly. In this regard, the database is configured to store the information about the changes occurred in the AR creation and timestamping thereof. Additionally, the modification of the virtual objects by the user within already published AR story creates another AR story. It will be appreciated that during modification the user is allowed to rescale, recolour, change texture, rotate or reposition the virtual objects of the published AR story and/or can add another virtual object to publish new AR story, this creates a timeline corresponding to the modification performed by the user on the original post. Moreover, the changes performed by all the users on the original AR story create the timeline that can be browsed by the user. Optionally, the timestamping enables the user to browse and revisit the AR creation at a particular time. Also enables the user to create a new version of any of the previous versions of the AR creation.

The term “timeline of the at least one AR story” as used herein refers to an arrangement of the one or more AR story in a specific order according to their publication. It will be appreciated that the specific order may be determined based on a time of creating said AR creation of the one or more AR story and the metadata associated therewith. Beneficially, the timeline allows the user to track different versions of the AR story. Notably, the AR story may have multiple AR stories chronologically arranged

Optionally, the first, second and additional metadata has an information about a position, a rotation, a colour or any other modification performed on the first, second and additional AR creations of the AR story, respectively. It will be appreciated that each AR creation has corresponding metadata containing information about a position, a rotation, a colour or any other modification performed thereon. Beneficially, the metadata having information enables the user to identify the changes performed on the AR creation. Notably, the metadata is linked with the database and the said database is available for the user to obtain the AR creation, created at a specific time based on the timestamping. For example, the first user created the first AR creation and time t1. The second user uses the AR creation of the first user to create the second AR creation. The third user creates the third AR creation using the second AR creation at time t3. Notably, each AR creation corresponding to time t1, t2 and t3 are timestamped in the database having corresponding metadata.

Optionally, the method further comprises iteratively repeating steps of receiving a selection of a virtual object from amongst the at least one first virtual object that is to be extracted from the first AR creation and digitally superimposing the virtual object on a representation of a second real-world environment to generate a second AR creation of the at least one AR story, to create additional AR creations of the at least one AR story. In this regard, the user can extract the virtual object from the AR creation and publish their version of AR creation. Moreover, the other users can extract the virtual objects from the published AR creation or can add virtual objects to create the AR creation. Notably, the user can create multiple AR creations of the original AR creation to form the at least one AR story.

Optionally, the method comprises publishing a given AR creation to a first file having a given format, wherein upon such publishing, the metadata of the given AR creation is saved as a second file that is linked to the first file. In this regard, the user can extract the virtual data from the AR creation, after extraction the user can modify the AR creation and create a new AR creation. Such new AR creation is saved as the second file having corresponding metadata data and corresponding timestamping.

Optionally, the given format is one of: an image format, a video format. Optionally, the image format, the video format provides the editable documents to the user that may be transferred by the one user to another user. Optionally, the given format may have an audio object to provide the audio. Optionally, the image format may be any one of: .tif, .tiff. .jpg, .jpeg, .png, .bmp, .gif, .raw and the like. Optionally, the video format may be any one of: .mp4, .avi, .mov, .flv, .3gp, webm, .mkv and the like Optionally, the method comprises recording the first, second and additional AR creations of the AR story. Beneficially, the recording of the first, second and additional AR creations of the AR story enables the user to publish the recorded AR creations of the AR story over the internet. For example, the recorded AR creation may be further published over a social networking website at a later moment of time.

The present disclosure also relates to the apparatus as described above. Various embodiments and variants disclosed above apply mutatis mutandis to the apparatus.

The term “apparatus” as used herein refers to an electronic device associated with (or used by) a user, that is capable of enabling the user to perform specific tasks. Notably, the apparatus is a user device. Optionally, the apparatus may include, but is not limited to, a cellular phone, personal digital assistants (PDAs), handheld devices, laptop computers, personal computers, and so forth, configured to provide the graphical user interface thereon, such as on the display screen thereof. Beneficially, the interaction between the user and the apparatus allows an effective operation and control therebetween.

The term “display screen” as used herein refers to the screen of the apparatus. Typically, the display screen may be configured to provide the visual graphic of the graphical user interface to the user. Optionally, the display screen may be selected from liquid crystal display (LCD) light-emitting diode (LED), backlit LCD, thin-film transistor (TFT) LCD, organic LED (OLED), Quantum dot (QLED) display, OLED display, AMOLED display, Super AMOLED display. Optionally, the display screen may comprise a protective covering to protect the display screen against any physical damage.

Optionally, the apparatus may comprise smart glasses such as AR glasses. Notably, the AR glasses are similar to normal glasses but usually have a thicker side. The AR glasses are configured to display an AR story thereon. In addition, the AR glasses enable user to make calls, answer messages, take photos and videos from your point of view, listen to music, interact with apps, use GPS navigation, and so forth. Optionally the AR glasses may be selected but not limited to monocular smart glasses, binocular smart glasses, Audio AR smart Glasses, immersive or Mixed reality smart glasses, mixed reality photo projection action, and the like.

The term “processor” as used herein refers to a computational element that is operable to respond to and processes instructions given by the user that drives the apparatus. The processor includes but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processor may refer to one or more individual processors, processing devices and various elements associated with a processing device that may be shared by other processing devices. Additionally, one or more individual processors, processing devices and elements are arranged in various architectures for responding to and processing the instructions that drive the apparatus.

Optionally, the processor is configured to iteratively repeating steps of receiving a selection of a virtual object from amongst the at least one first virtual object that is to be extracted from the first AR creation and digitally superimposing the virtual object on a representation of a second real-world environment to generate a second AR creation of the at least one AR story, to create additional AR creations of the at least one AR story.

Optionally, the processor is configured to manipulate a given virtual object upon its digital superimposition in a representation of a given real-world environment.

Optionally, the processor is configured to publish a given AR creation to a first file having a given format, wherein upon such publishing, the metadata of the given AR creation is saved as a second file that is linked to the first file.

Optionally, the given format is one of: an image format, a video format.

The present disclosure also relates to the system as described above. Various embodiments and variants disclosed above apply mutatis mutandis to the system.

It will be appreciated that the plurality of apparatuses is only used in plural corresponding to the aforementioned apparatus of the second aspect. Herein the plurality of apparatuses may be collaborating on a same software application managed by the server.

The term “server” as used herein refers to a powerful physical or virtual infrastructure that has been virtualized, to perform application- and information-processing storage and enable accessing of the stored information by users remotely over a network. The server includes suitable logic, circuitry, interfaces, and/or code that is configured to store, process and/or receive the information from the apparatus corresponding to the AR creation and the AR story. Moreover, the server is configured to associate the corresponding metadata with respect to the AR creation. It will be appreciated that the server may be a cloud server. In addition, the server may be both a single server and/or a plurality of servers operating in a parallel or distributed architecture to operatively couple with the disclosed apparatus or similar systems. Examples of the server include, but is not limited to, a storage server, a web server, an application server, or a combination thereof. Moreover, the server is also configured to have the server processor to process the requested user actions.

The present disclosure also relates to the computer program product as described above. Various embodiments and variants disclosed above apply mutatis mutandis to the computer program product.

Optionally, the computer program product is implemented as an algorithm, embedded in a software stored in the non-transitory computer-readable storage medium. The non-transitory computer-readable storage medium may include, but is not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

### DETAILED DESCRIPTION OF THE DRAWINGS

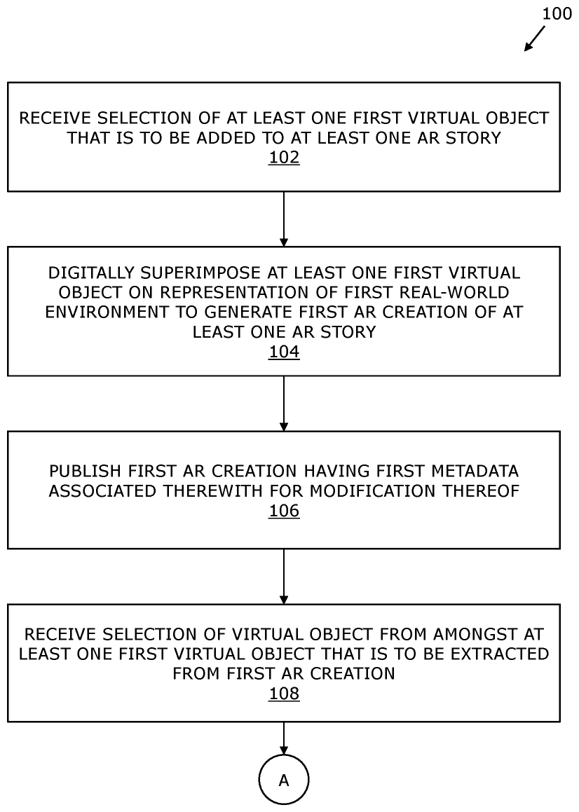

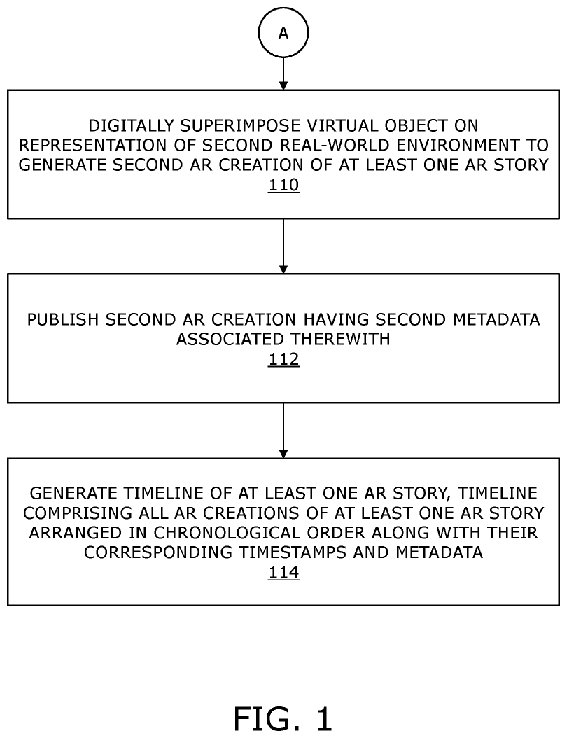

Referring to FIG. 1, illustrated is a flowchart 100 depicting steps of a method for collaboratively creating at least one augmented reality (AR) story, in accordance with an embodiment of the present disclosure. At step 102, a selection of at least one first virtual object that is to be added to the at least one AR story is received. At step 104, the at least one first virtual object is digitally superimposed on a representation of a first real-world environment to generate a first AR creation of the at least one AR story. At step 106, the first AR creation having a first metadata associated therewith for modification thereof is published. At step 108, a selection of a virtual object from amongst the at least one first virtual object that is to be extracted from the first AR creation is received. At step 110, the virtual object is digitally superimposed on a representation of a second real-world environment to generate a second AR creation of the at least one AR story. At step 112, the second AR creation having a second metadata associated therewith is published. At step 114, a timeline of the at least one AR story is generated, the timeline comprising all the AR creations of the at least one AR story arranged in a chronological order along with their corresponding timestamps and metadata.

The steps 102, 104, 106, 108, 110, 112 and 114 are only illustrative and other alternatives can also be provided where one or more steps are added, one or more steps are removed, or one or more steps are provided in a different sequence without departing from the scope of the claims herein.

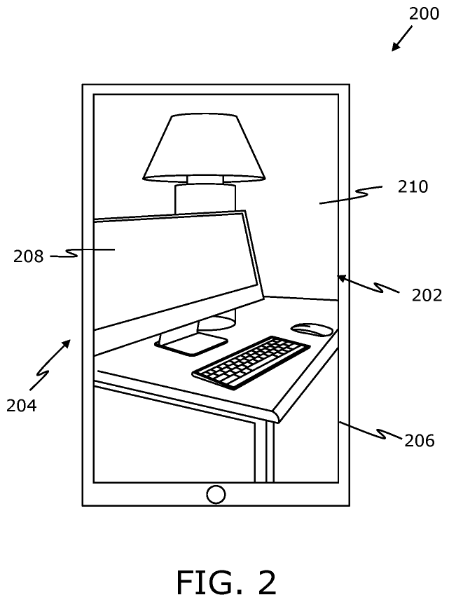

Referring to FIG. 2, illustrated is an exemplary illustration 200 of an AR creation 202, in accordance with an embodiment of the present disclosure. As shown, an apparatus 204 comprising a display screen 206, displaying AR creation 202. Notably, the virtual object 208 (such as monitor) is digitally superimposed on a representation of a real-world environment 210 to generate the AR creation 202. In this regard, the user is able to interact and can modify the virtual object 208.

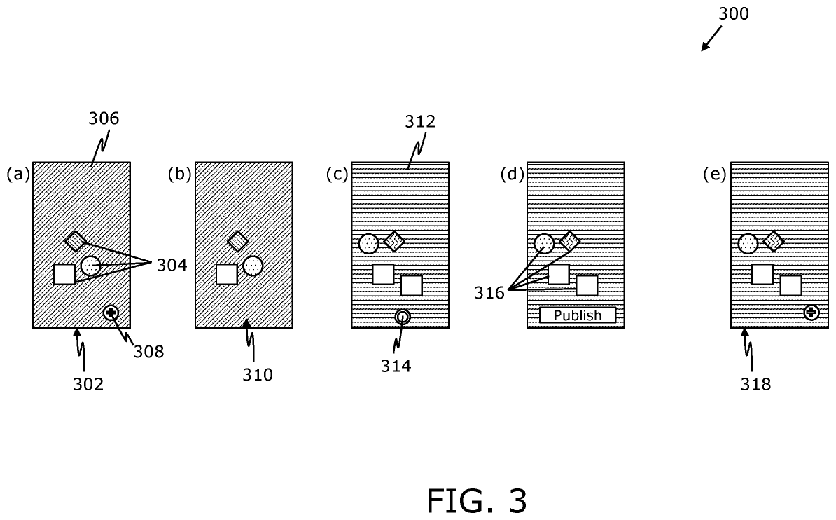

Referring to FIG. 3, illustrated is an exemplary illustration 300 of creating at least one augmented reality (AR) story, in accordance with an embodiment of the present disclosure. As shown, at (a) the original AR creation 302 having first virtual objects 304 and first real-world environment 306 is published by a first user. At (b) the second user copy the AR creation of the first user by using the edit icon 308 on a user interface 310. At (c) the second user changes the first real-world environment 306 to the second real-world environment 312 using the camera by pressing a camera icon 314 of the apparatus and modify the first virtual objects 304 to the second virtual objects 316. That is, the second user's environment is shown automatically after pressing the edit icon 308 and the first virtual objects 304 are visible. The camera icon 314 is used to record a photo/video prior to publishing. At (d) the second user publishes the second AR creation 318. At (e) the second AR creation 318 creation by the second user is published and can be used by other users.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for collaboratively creating at least one augmented reality (AR) story, the method comprising:
a. receiving a selection of at least one first virtual object that is to be added to the at least one AR story;
b. digitally superimposing the at least one first virtual object on a representation of a first real-world environment to generate a first AR creation of the at least one AR story;
c. publishing the first AR creation having a first metadata associated therewith for modification thereof;
d. receiving a selection of a virtual object from amongst the at least one first virtual object that is to be extracted from the first AR creation;
e. digitally superimposing the virtual object on a representation of a second real-world environment to generate a second AR creation of the at least one AR story;
f. publishing the second AR creation having a second metadata associated therewith; and
g. generating a timeline of the at least one AR story, the timeline comprising all the AR creations of the at least one AR story arranged in a chronological order along with their corresponding timestamps and metadata.

2. The method according to claim 1, further comprising iteratively repeating steps (d) to (e) to create additional AR creations of the at least one AR story.

3. The method according to claim 1, further comprising manipulating a given virtual object upon its digital superimposition in a representation of a given real-world environment.

4. The method according to claim 1, wherein the first, second and additional metadata has an information about a position, a rotation, a colour or any other modification performed on the first, second and additional AR creations of the AR story, respectively.

5. The method according to claim 1, wherein the method comprises linking, in a database, the first, second and additional AR creations of the AR story and the first, second and additional metadata in a chronological order.

6. The method according to claim 1, further comprising publishing a given AR creation to a first file having a given format, wherein upon such publishing, the metadata of the given AR creation is saved as a second file that is linked to the first file.

7. The method according to claim 6, wherein the given format is one of: an image format, a video format.

8. The method according to claim 1, wherein the method comprises obtaining the representation of the given real-world environment from a data repository or a camera of a given user device.

9. The method according to claim 1, wherein the method comprises recording the first, second and additional AR creations of the AR story.

10. An apparatus for collaboratively creating at least one augmented reality (AR) story, the apparatus comprising:
a display screen; and
a processor configured to:
a. receive a selection of at least one first virtual object that is to be added to the at least one AR story;
b. digitally superimpose the at least one first virtual object on a representation of a first real-world environment to generate a first AR creation of the at least one AR story;
c. publish the first AR creation having a first metadata associated therewith for modification thereof;
d. receive a selection of a virtual object from amongst the at least one first virtual object that is to be extracted from the first AR creation;
e. digitally superimpose the virtual object on a representation of a second real-world environment to generate a second AR creation of the at least one AR story;
f. publish the second AR creation having a second metadata associated therewith; and
g. generate a timeline of the at least one AR story, the timeline comprising all the AR creations of the at least one AR story arranged in a chronological order along with their corresponding timestamps and metadata.

11. The apparatus according to claim 10, wherein the processor is configured to iteratively repeating steps (d) to (e) to create additional AR creations of the at least one AR story.

12. The apparatus according to claim 10, wherein the processor is configured to manipulate a given virtual object upon its digital superimposition in a representation of a given real-world environment.

13. The apparatus according to claim 10, wherein the processor is configured to publish a given AR creation to a first file having a given format, wherein upon such publishing, the metadata of the given AR creation is saved as a second file that is linked to the first file.

14. The apparatus according to claim 13, wherein the given format is one of: an image format, a video format.

15. A system comprising a server communicably coupled to a plurality of apparatuses according to claim 10, wherein the plurality of apparatuses for collaboratively creating at least one augmented reality (AR) story, the server being configured to store, in a database associated with the server, a timeline of at least one AR story, the timeline comprising all AR creations of the at least one AR story arranged in a chronological order along with their corresponding timestamps and metadata.

16. A computer program product comprising a non-transitory computer-readable storage medium having computer-readable instructions stored thereon, the computer-readable instructions being executable by a computing device comprising processor to execute a method as claimed in claim 1.
